(19) United States
(12) Patent Application Publication
(10) Pub. No.: US 2015/0186808 A1
(43) Pub. Date: Jul. 2, 2015

(54) CONTEXTUAL DATA ANALYSIS USING DOMAIN INFORMATION

(71) Applicant: International Business Machines Corporation, Armonk, NY (US)

(72) Inventors: Martin Petitclerc, Saint-Nicolas (CA); Mohsen M. Rais-Ghasem, Ottawa (CA); Anatoly Tulchinksy, Nepean (CA)

(73) Assignee: International Business Machines Corporation, Armonk, NY (US)

(21) Appl. No.: 14/141,950

(22) Filed: Dec. 27, 2013

(51) Int. Cl. G06Q 10/06

(52) U.S. Cl. CPC G06Q 10/067; G06Q 10/0637

(57) ABSTRACT

Techniques are described for modeling information from a data source. In one example, a method includes receiving a data set. The method further includes defining at least one generic domain that provides a group of default concepts. The method further includes receiving a selection of an indication of at least one domain extension that extends the group of default concepts provided by the at least one generic domain, wherein the at least one domain extension includes concepts for a specific industry. The method further includes generating based on the data set and a combination attic at least one generic domain and the at least one domain extension, a model and a domain.

### TECHNICAL FIELD

The disclosure relates to business intelligence systems, and more particularly, to query recommendations for business intelligence systems.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher level areas of responsibility in the organization. Moreover, once data has been entered, it must be retrieved to be utilized. The system may perform mathematical calculations on the data, combining data submitted by many users. Using the results of these calculations, the system may generate reports for review by higher management. Often, these complex systems make use of multidimensional data sources that organize and manipulate the tremendous volume of data using data structures referred to as data cubes. Each data cube, for example, includes a plurality of hierarchical dimensions having levels and members for storing the multidimensional data.

Business intelligence (BI) systems may be used to provide insights into such collections of enterprise data. At the heart of a BI system may typically be a conceptual model that represents the business interpretation or business meaning of the enterprise data. Navigation or analysis of the enterprise data is ultimately grounded in such a conceptual model. BI systems also now may typically incorporate data from various collections of data with no pre-defined relationships, such as spreadsheets and comma-separated values (CSV) files.

### SUMMARY

Techniques are described that may improve the accuracy of recommendations, such as queries, reports, and data visualizations, according to some examples. One or more techniques may, for example, provide hardware, firmware, software, or some combination thereof operable to provide customized recommendations while potentially minimizing the need for user interaction. That is, one or more techniques of the present disclosure may enable a computing device or computer system to create and display queries, reports, and visualizations in a way that allows users to more easily understand and consume the data while allowing minimal user input.

In one example, a method comprising receiving, by one or more processors of a business intelligence system, a data set. The method further comprising defining, by the one or more processors, at least one generic domain that provides a group of default concepts. The method further comprising receiving, by the one or more processors, a selection of an indication of at least one domain extension that extends the group of default concepts provided by the at least one generic domain, wherein the at least one domain extension includes concepts for a specific industry. The method further comprising generating, by the one or more processors and based on the data set and a combination of the at least one generic domain and the at least one domain extension, a model and a domain, wherein the generating comprises assigning, by the one or more processors, one or more concepts to the data set to generate the domain, the one or more concepts being selected from one or more of the at least one generic domain and the at least one domain extension, and defining, by the one or more processors, one or more relationships between the one or more concepts and the data set to generate the model.

In another example, a computer system, comprising at least one processor, wherein the at least one processor is configured to receive a data set, define at least one generic domain that provides a group of default concepts, receive a selection of an indication of at least one domain extension that extends the group of default concepts provided by the at least one generic domain, wherein the at least one domain extension includes concepts for a specific industry, and generate based on the data set and a combination of the at least one generic domain and the at least one domain extension, a model and a domain. The generating further comprises assigning one or more concepts to the data set to generate the domain, the one or more concepts being selected from one or more of the at least one generic domain and the at least one domain extension, and defining one or more relationships between the one or more concepts and the data set to generate the model.

In another example, a computer program product comprising a computer-readable storage medium having program code embodied therewith, the program code executable by at least one processor to receive a data set, define at least one generic domain that provides a group of default concepts, receive a selection of an indication of at least one domain extension that extends the group of default concepts provided by the at least one generic domain, wherein the at least one domain extension includes concepts for a specific industry, and generate based on the data set and a combination of the at least one generic domain and the at least one domain extension, a model and a domain. The generating comprises assigning one or more concepts to the data set to generate the domain, the one or more concepts being selected from one or more of the at least one generic domain and the at least one domain extension, and defining one or more relationships between the one or more concepts and the data set to generate the model.

The details of one or more examples are set forth in the accompanying drawings and the description below. Other features will be apparent from the description and drawings, and from the claims.

### BRIEF DESCRIPTION OF DRAWINGS

FIG. 1 is a block diagram illustrating an example enterprise system having a computing environment in which users interact with an enterprise business intelligence (BI) system and data sources accessible over a public network, according to one or more aspects of the present disclosure.

FIG. 2 is a block diagram illustrating one example of the enterprise system shown in FIG. 1, according to one or more aspects of the present disclosure.

FIGS. 3A & 3B are block diagrams that illustrate one or more examples of an overall architecture of a model and domain constructor in an operating context for modeling enterprise data, according to one or more aspects of the present disclosure.

FIG. 4 is a block diagram illustrating details of an example model and domain that may be generated based on a data set, according to one or more aspects of the present disclosure.

FIG. 5 is a flow chart illustrating an example of a process for modeling of enterprise data in an enterprise system, according to one or more aspects of the present disclosure.

FIG. 6 is a flow chart illustrating an example of a process for executing a model and domain constructor with a domain extension as part of an enterprise BI system, according to one or more aspects of the present disclosure.

### DETAILED DESCRIPTION

Various examples are disclosed herein for a model and domain constructor in a business intelligence system for automatic assigning of relationships (i.e., modeling) and defining of concepts (i.e. domain) between various data of a data source. In various examples, a model and domain constructor may automatically provide a model and a domain of a data source by using detection rules and clues, and by applying concepts from both common and specific business oncologies to data item headings and data items in the data source. By applying concepts from both common and specific business oncologies, model and domain constructor generates associations among categories of data, and define concepts between the categories of data, as part of constructing a model and domain of the data. The model and domain of the data may be used by a recommendation application to generate recommendations of queries, reports, and data visualizations that provide end users with a high-level analysis and insight into the data.

Constructing such a conceptual model may typically require explicit intervention and manual data modeling by an expert data modeler. A BI system may use such a manually created data model to organize and describe large bodies of enterprise data to support useful business intelligence toots. A data model may contain descriptions of the structure and context of the data, and support queries of the data with the BI system. The data model may contain descriptions of the structure and nature of the data, such as portions of the data that are categories and portions of the data that are numeric metrics, for example. Such descriptions of the data may provide enough contexts to the BI system to allow it to create useful queries.

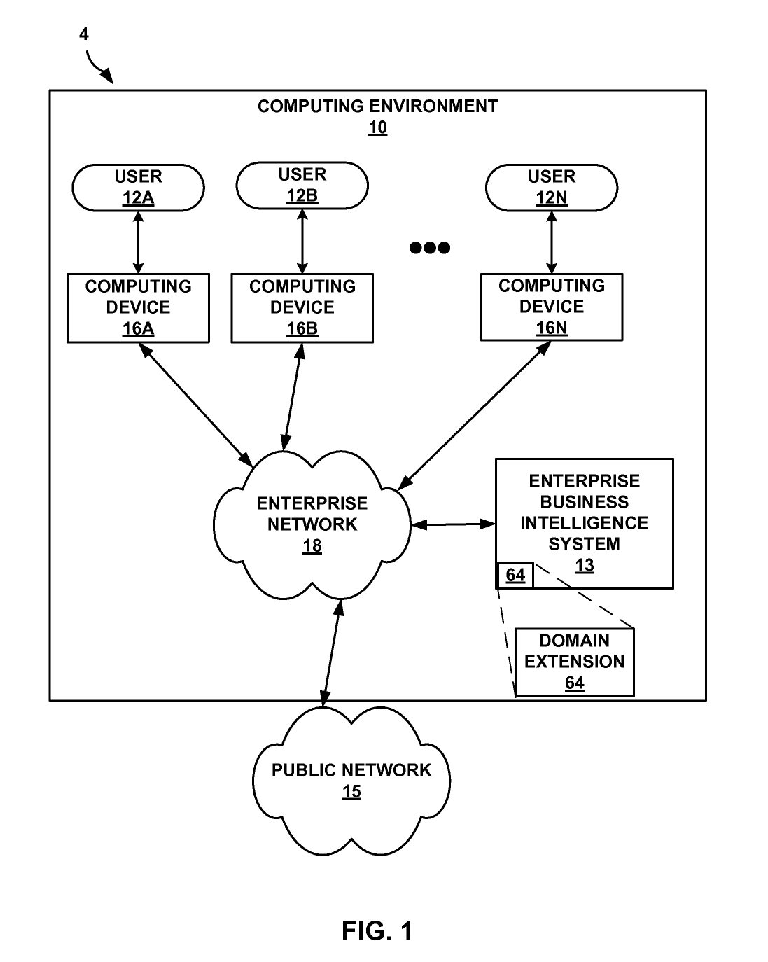

FIG. 1 is a block diagram illustrating an example enterprise system 4 having a computing environment 10 in which a plurality of users 12A-12N (collectively, “users 12”) may interact with an enterprise business intelligence (BI) system 13 and data sources accessible over public network 15, according to one or more aspects of the present disclosure. In enterprise system 4 shown in FIG. 1, enterprise business intelligence system 13 is communicatively coupled to a number of client computing devices 16A-16N (collectively, “client computing devices 16” or “computing devices 16”) by an enterprise network 18. Users 12 interact with their respective computing devices to access enterprise business intelligence system 13. Users 12, computing devices 16A-16N, enterprise network 18, and enterprise business intelligence system 13 may all be either in a single facility or widely dispersed in two or more separate locations anywhere in the world, in different examples

For exemplary purposes, various examples of the techniques of this disclosure may be readily applied to various software systems, including enterprise business intelligence systems or other large-scale enterprise software systems. Examples of enterprise software systems include enterprise financial or budget planning systems, order management systems, inventory management systems, sales force management systems, business intelligence tools, enterprise reporting tools, project and resource management systems, and other enterprise software systems.

In this example, enterprise BI system 13 includes servers that execute BI dashboard web applications and business analytics software. A user 12 may use a BI portal on a client computing device 16 to view and manipulate information such as business intelligence reports (“BI reports”) using a generic domain with domain extension 64 and other collections and visualizations of data via the respective computing device 16.

Domain extension 64 may represent an extension of a domain, such as a generic domain, using industry specific concepts defined by at least one of enterprise users 12 or at least one of a non-enterprise user. In some examples, the industry specific concepts may include banking, insurance, financial markets, healthcare provider & plan, telecommunication, and retail. In addition, this may include data from any of a wide variety of sources, including from multidimensional data structures and relational databases within enterprise system 4, as well as data from a variety of external sources that may be accessible over public network 15.

Users 12 may use a variety of different types of computing devices 16 to interact with enterprise business intelligence system 13 and access data visualization tools and other resources via enterprise network 18. For example, an enterprise user 12 may interact with enterprise business intelligence system 13 and run a business intelligence (BI) portal (e.g., a business intelligence dashboard) using a laptop computer, a desktop computer, or the like, which may run a web browser. Alternatively, an enterprise user may use a smartphone, tablet computer, or similar device, running a business intelligence dashboard in either a web browser or a dedicated mobile application for interacting with enterprise business intelligence system 13.

Enterprise network 18 and public network 15 may represent any communication network, and may include a packet-based digital network such as a private enterprise intranet or a public network like the Internet. In this manner, computing environment 10 can readily scale to suit large enterprises. Enterprise users 12 may directly access enterprise business intelligence system 13 via a local area network, or may remotely access enterprise business intelligence system 13 via a virtual private network, remote dial-up, or similar remote access communication mechanism.

In one example of FIG. 1, enterprise BI system 13 may receive, by one or more processors of the BI system, a data set, and define at least one generic domain that provides a group of default concepts. Moreover, enterprise BI system 13 by the one or more processors may receive a selection of an indication of at least one domain extension, such as domain extension 64 that extends the group of default concepts provided by the at least one generic domain, wherein the at least one domain extension includes concepts for a specific industry. Further, enterprise BI system 13 may generate, by the one or more processors and based on the data set and a combination of the at least one generic domain and the at least one domain extension, a model and a domain. The generating comprises assigning, by the one or more processors, one or more concepts to the data set to generate the domain, the one or more concepts being selected from one or more of the at least one generic domain and the at least one domain extension, and defining, by the one or more processors, one or more relationships between the one or more concepts and the data set to generate the model.

In another example of FIG. 1, a computing device, may include at least one processor, wherein the at least one processor is configured to receive a data set, define at least one generic domain that provides a group of default concepts, receive a selection of an indication of at least one domain extension that extends the group of default concepts provided by the at least one generic domain, wherein the at least one domain extension includes concepts for a specific industry, and generate based on the data set and a combination of the at least one generic domain and the at least one domain extension, a model and a domain. The generating may further includes assigning one or more concepts to the data set to generate the domain, the one or more concepts being selected from one or more of the at least one generic domain and the at least one domain extension, and defining one or more relationships between the one or more concepts and the data set to generate the model.

In another example of FIG. 1, a computer program product may include a computer-readable storage medium having program code embodied therewith, the program code executable by at least one processor to receive a data set, define at least one generic domain that provides a group of default concepts, receive a selection of an indication of at least one domain extension that extends the group of default concepts provided by the at least one generic domain, wherein the at least one domain extension includes concepts for a specific industry, and generate based on the data set and a combination of the at least one generic domain and the at least one domain extension, a model and a domain. The generating may further include assigning one or more concepts to the data set to generate the domain, the one or more concepts being selected from one or more of the at least one generic domain and the at least one domain extension, and defining one or more relationships between the one or more concepts and the data set to generate the model.

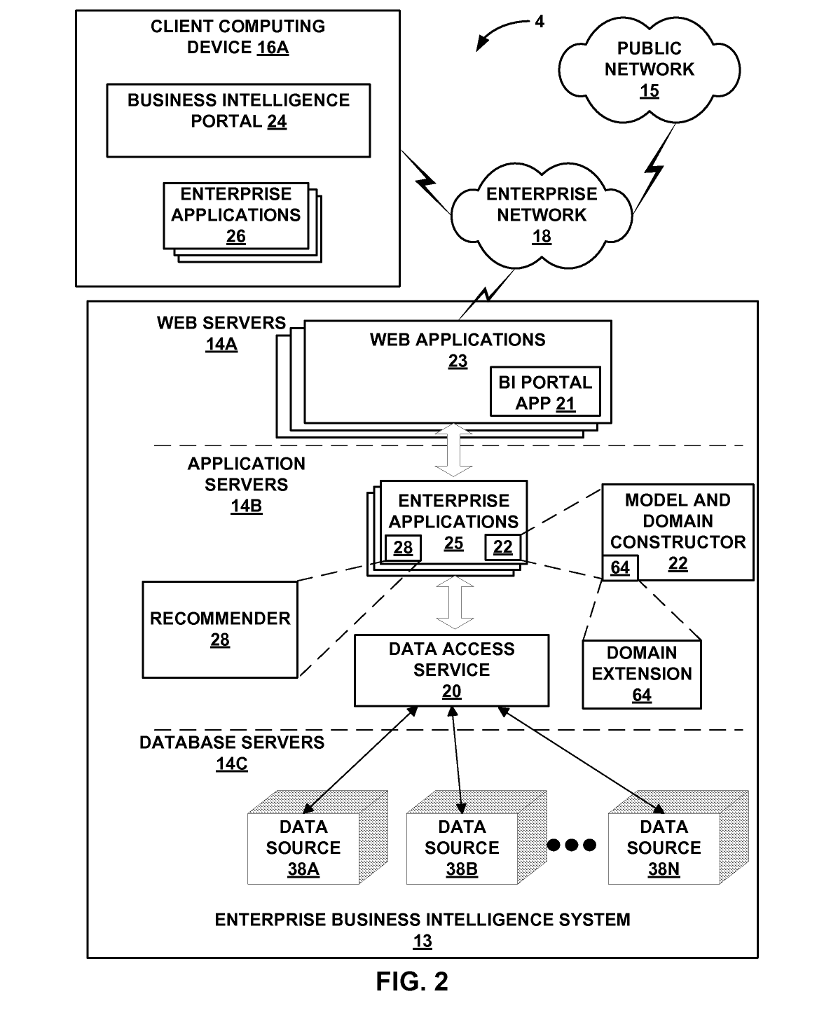

FIG. 2 is a block diagram illustrating one example of enterprise system 4 shown in FIG. 1, according to one or more aspects of the present disclosure. In this example implementation, a single client computing device 16A is shown for purposes of illustration and includes BI portal 24 and one or more client-side enterprise software applications 26 that may utilize and manipulate multidimensional data, including a view of data visualizations and analytical tools with BI portal 24. BI portal 24 may, in various examples, be rendered within a general web browser application, within a locally hosted application or mobile application, or other user interface. BI portal 24 may be generated or rendered using any combination of application software and data local to the computing device it is being generated on, and/or remotely hosted in one or more application servers or other remote resources.

BI portal 24 may output data visualizations for a user to view and manipulate in accordance with various techniques described in further detail below. BI portal 24 may present data in the form of charts or graphs that a user may manipulate, for example. BI portal 24 may present visualizations of data based on data from sources such as a BI report, e.g., that may be generated with enterprise business intelligence system 13, or another BI dashboard, as well as other types of data sourced from external resources through public network 15. BI portal 24 may present visualizations of data based on data that may be sourced from within or external to the enterprise.

FIG. 2 depicts additional detail for enterprise business intelligence system 13 and how it may be accessed via interaction with a BI portal 24 for depicting and providing visualizations of business data. BI portal 24 may provide visualizations of data that represents, provides data from, or links to any of a variety of types of resource, such as a BI report, a software application, a database, a spreadsheet, a data structure, a flat file, Extensible Markup Language (“XML”) data, a comma separated values (CSV) file, a data stream, unorganized text or data, or other type of file or resource. BI portal 24 may also provide recommended queries, reports, or visualizations of data by recommender 28 based on data modeling information generated by model and domain constructor 22 (hereinafter “model and domain constructor” or “model and domain constructor” using a generic domain and domain extension 64. In one example, model and domain constructor 22 may be smart metadata (SMD) used to assign concepts to data and define relationships between data in a data set. Model and domain constructor 22 and recommender 28 may be hosted among enterprise applications 25, as in the example depicted in FIG. 2, or may be hosted elsewhere, including on a client computing device 16A, or distributed among various computing resources in enterprise business intelligence system 13, in some examples. Model and domain constructor 22 and recommender 28 may be implemented as or take the form of a stand-atone application, a portion or add-on of a larger application, a library of application code, a collection of multiple applications and/or portions of applications, or other forms, and may be executed by any one or more servers, client computing devices, processors or processing units, or other types of computing devices.

As depicted in the example of FIG. 2, enterprise business intelligence system 13 is implemented in accordance with a three-tier architecture: (1) one or more web servers 14A that provide web applications 23 with user interface functions, including a server-side BI portal application 21; (2) one or more application servers 14B that provide an operating environment for enterprise software applications 25 and a data access service 20; and (3) database servers 14C that provide one or more data sources 38A, 38B, . . . , 38N (“data sources 38”). Enterprise software applications 25 may include model and domain constructor 22 with domain extension 64 as one of enterprise software applications 25 or as a portion or portions of one or more of enterprise software applications 25. In another example, enterprise software application 25 may also include a recommender tool 28 as one of enterprise software applications 25 or as a portion or portions of one or more enterprise software applications 25. The data sources 38 may include two-dimensional databases and/or multidimensional databases 42 or data cubes 44. The data sources may be implemented using a variety of vendor platforms, and may be distributed throughout the enterprise. As one example, the data sources 38 may be multidimensional databases configured for Online Analytical Processing (OLAP). As another example, the data sources 38 may be multidimensional databases configured to receive and execute Multidimensional Expression (MDX) queries of some arbitrary level of complexity. As yet another example, the data sources 38 may be two-dimensional relational databases configured to receive and execute SQL queries, also with an arbitrary level of complexity.

In one or more examples, multidimensional data structures are “multidimensional” in that each multidimensional data element is defined by a plurality of different object types, where each object is associated with a different dimension. The enterprise applications 26 on client computing device 16A may issue business queries to enterprise business intelligence system 13 to build reports or visualizations. Enterprise business intelligence system 13 includes a data access service 20 that provides a logical interface to the data sources 38. Client computing device 16A may transmit query requests through enterprise network 18 to data access service 20. Data access service 20 may, for example, execute on the application servers intermediate to the enterprise software applications 25 and the underlying data sources in database servers 14C. Data access service 20 retrieves a query result set from the underlying data sources, in accordance with query specifications. Data access service 20 may intercept or receive queries, e.g., by way of an API presented to enterprise applications 26. Data access service 20 may then return this result set to enterprise applications 26 as BI reports, other BI objects, and/or other sources of data that are made accessible to BI portal 24 on client computing device 16A. These may include concept enterprise data modeling information generated by model and domain constructor 22.

Model and domain constructor 22 may provide data modeling for any one or more of a multidimensional data structure or data cube 44, database 42, spreadsheet 46, CSV file 48, RSS feed 50, or other data source 52. Spreadsheet 46 includes cells arranged in an array, organized in rows and columns, and each cell of the array may contain either numeric data or text data, or formulaic data regarding one or more cells. CSV file 48 otherwise known as a comma-separated values file stores tabular data (i.e., numeric and text data) in plain-text form (i.e., a sequence of characters with no data that has to be interpreted as binary numbers RSS Feed 50 otherwise known as rich site summary, uses a family of standard web feed formats to publish frequently updated information, such as blog entries, video, audio, and news headlines. RSS Feed 50 may include an RSS document, which includes full or summarized text, and metadata, such as publishing date and author's name. Other data source 52 may be any other numeric or text data that can be processed by enterprise BI system 13 or computing device 16 as depicted in FIG. 1, or servers 14A-14C as depicted in FIG. 2.

Model and domain constructor 22 may provide automatic data modeling of a data source by analyzing data item headings and other data from the data source with reference to both a business ontology and a set of detection rules, and thereby map the data to higher-level meanings in the context of the applicable business or other enterprise. Data item headings may be column headings, row headings, sheet names, graph captions, file names, document titles, or other forms of headings for lists, categories, time-ordered variables, or other forms of data items from a data source, for example. Model and domain constructor 22 may also use the matching of data item headings to concepts in automatically generating data visualizations appropriate to the data associated with the data item headings, such as trend analysis graphs for time-ordered data or charts organized by entity names, for example, as further described below.

A business intelligence system comprising model and domain constructor 22 may provide insights into a user's data that may be more targeted and more usefill, and may automatically describe the nature of the data based on a business ontology and a set of detection rules, rather than requiring manual data modeling. For example, a BI system incorporating model and domain constructor 22 may identify that a set of data from a data source pertains to how one or more values vary over time, and the system may output the set of data in an interface mode that is ordered by time, such as a trend analysis graph or a calendar, for example. A BI system incorporating model and domain constructor 22 may also model data from unmodeled sources, such as spreadsheets, CSV files, or RSS feeds, and data in multiple languages.

Model and domain constructor 22 may therefore provide more intelligent modeling and organization of enterprise data. This may include model and domain constructor 22 identifying data item headings with concepts defining what the data is related to, from data in either a modeled data source or an unmodeled data source (e.g., a spreadsheet or CSV file). For example, model and domain constructor 22 may identify a data item heading, such as the title of a column in a spreadsheet, as being associated with a particular concept of time. Model and domain constructor 22 may output this identification of the data item heading with this particular concept as part of a data model and domain to a consuming application or system, such as a BI dashboard or other type of BI portal, which may use this identification to extrapolate that it can generate a time-based data visualization, such as a trend analysis graph, with the data from the data source.

Model and domain constructor 22 may make use of a business ontology that may include externalized business oncologies describing business concepts in multiple languages, for example. Model and domain constructor 22 may make use of an externalized business ontology, such as domain extension 64 that may include common and business-specific concepts such as time (e.g., year, quarter), geography (e.g., city, country), product, revenue, and so on. Model and domain constructor 22 may make use of such a business ontology, like domain extension 64, as well as a set of detection rules to automatically model information from a data source. Model and domain constructor 22 may provide a heuristic approach that may often correctly model and describe a dataset for a consuming BI application. Model and domain constructor 22 may thereby, in some examples, provide insight into the data without the need for manual data modeling, and quickly provide targeted insights into the data. That is, in one example, model and domain constructor 22 may construct a conceptual model that represents the business interpretation or business meaning of a data set or data source based on a generic domain with default business concepts. In another example, model and domain constructor 22 may also construct a conceptual model that represents the business interpretation or business meaning of a data set or data source based on a generic domain and domain extension 64 with default and customized business concepts. By using domain extension 64 with customized industry specific concepts generated by an expert on business ontology and/or a specific company or business, model and domain constructor 22 does not require explicit intervention and manual data modeling by an expert data modeler. In one example, domain extension 64 may be identify and group related data items and assigning them specific roles based on business information unique to one company.

For example, a data set may include ProductName and ProductCode as two data item headings that may be related and unique to one company, and ProductName may be used as a caption, while ProductCode may be used as an identifier. Another example may involve identifying data items that hold whole-part associations among them, such as State and City. Model and domain constructor 22 may eliminate or significantly reduce the need for manual data modeling by automatically construct such a business model. Model and domain constructor 22 may construct a business model and domain from a variety of data sources, from fully structured enterprise data sources to semi-structured sources, such as a spreadsheet or CSV file.

Model and domain constructor 22 may primarily use lexical clues and various data hints to create a mapping between the data items in a data source and various business concepts. The mapping between the data items may include assigning one or more concepts to the data set to generate the domain, the one or more concepts being selected from one or more of the at least one generic domain and the at least one domain extension, and defining, one or more relationships between the one or more concepts and the data set to generate the model. Model and domain constructor 22 may ultimately build a business model and a domain based on such mappings between data items and business concepts. Such a business model and domain created by model and domain constructor 22 may then be used to offer insightful analyses, such as in a BI dashboard or any type of BI portal, BI user interface, and/or BI data visualization For example, given a set of data items representing product, revenue, and time, model and domain constructor 22 may automatically construct a model and domain that enables a BI system to automatically generate analyses to chart product revenue trend over time or to compare product revenues for a particular period of time, as illustrative examples. In another example, given a set of data items representing product, revenue, and time, model and domain constructor 22 may automatically construct a model and domain that enables a BI system with recommender 28 to automatically generate recommendations, such as queries, reports, or visualizations to users 12 to chart product revenue trend over time or to compare product revenues for a particular period of time, as illustrative examples.

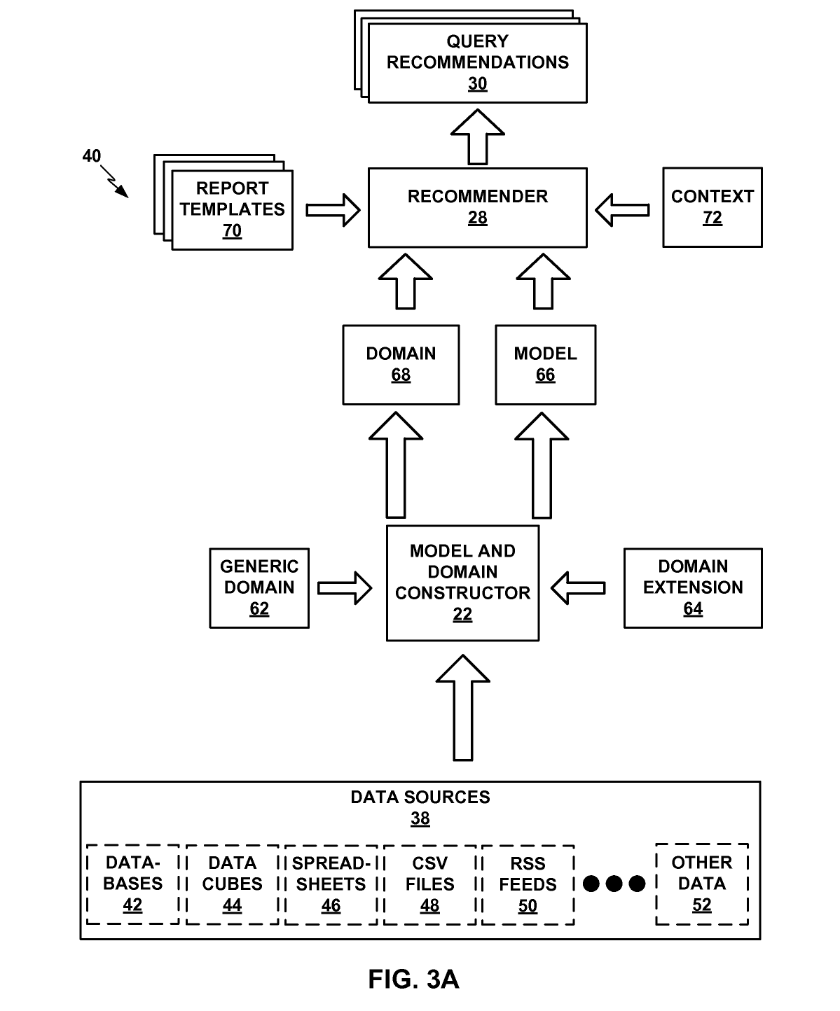

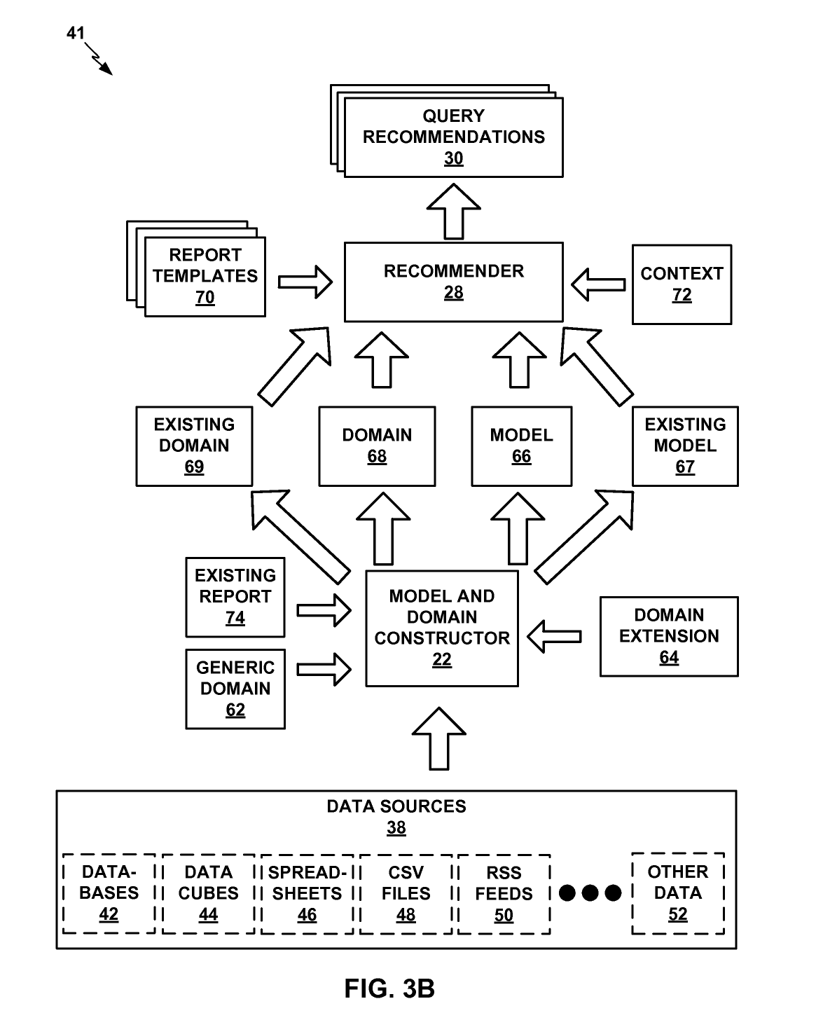

FIGS. 3A & 3B are block diagrams that illustrate one or more examples of an overall process of a model and domain constructor in an operating context for modeling enterprise data, according to one or more aspects of the present disclosure. Central to the process is a business ontology with concepts representing both the common knowledge, such as generic domain 62, and specific business knowledge, such as domain extension 64. As one example, through this business ontology, model and domain constructor 22 may retain a conceptual model indicating that businesses often organize product offerings in categories e.g., product lines, brands, and individual items). As another example, through this business ontology, model and domain constructor 22 may retain a conceptual model indicating that a sales order may typically include one or more sales items, a base price for each of the one or more sales items, potentially a discount on the base price, and a client that has placed the sales order, among other things.

In the example process 40 of FIG. 3A, model and domain constructor 22 may use another source of information that includes a system of rules and clues to detect business concepts and scenarios. This system of rules and clues may generally be organized into two categories, lexical such as label) and value-based (such as data patterns or exemplar values). Lexical clues, by their nature, may be ambiguous and model and domain constructor 22 may manage such ambiguities by various means including contextual clues.

As an example of using contextual clues to disambiguate lexical clues, model and domain constructor 22 may encounter a data item heading that consists of or includes the word “volume,” the meaning of which may be ambiguous in isolation. Model and domain constructor 22 may evaluate potential contextual clues in content surrounding the data item heading consisting of or including the term “volume.” The surrounding content, such as other, horizontally or vertically proximate (described below) data item headings, may contain other terms that serve as contextual clues related either to stock market trading, or to cargo delivery, for example. If model and domain constructor 22 discovers contextual clues related to stock market trading, model and domain constructor 22 may then determine that the data item heading “volume” is associated with a business concept of quantity, and in particular of quantity of stocks. On the other hand, if model and domain constructor 22 discovers contextual clues related to cargo delivery, model and domain constructor 22 may then determine that the data item heading “volume” is associated with a business concept of a three-dimensional physical volume capacity, and in particular of a three-dimensional physical volume of cargo capacity.

Data item headings may be horizontally proximate to a particular data item heading of interest if they are additional data item headings of the same form of the particular data item heading and part of the same file, directory, or other environment as the particular data item heading. For example, if the particular data item heading of interest is a column heading in a spreadsheet, the other column headings in the spreadsheet may be considered horizontally proximate to the particular data item heading. Data item headings may be vertically proximate to a particular data item heading of interest if they are hierarchically separated from the particular data item heading within an organizational hierarchy of file portions, file, directory, etc., such that one is included as part of the other.

For example, if the particular data item heading of interest is a column heading in a spreadsheet, then vertically separated data item headings relative to that column heading may include the sheet name of the sheet in which the column appears, the internally written title of the sheet, the file name of the spreadsheet file, or the directory name of a directory that contains the spreadsheet file, for example. In a particular example related to a column heading of interest named “volume” as in the example described above, model and domain constructor 22 may evaluate horizontally and/or vertically proximate data item headings and discover that the sheet name and the file name of the sheet and file that contain the column both include content that makes reference to stock market trades. Model and domain constructor 22 may take these clues in the vertically proximate data item headings to be contextual clues to the conceptual nature of the column heading of interest, in this example.

In one example, model and domain constructor 22 may include or access a single hierarchy of concepts organized as generic domain 62, and a series of business-specific concepts provided by an expert (e.g., business ontology, the specific business) as domain extension 64 (e.g., concepts unique to that specific business) and model data in a mapping with relationships and patterns defined in the business ontology. As simple examples of concepts, the concept “Sales Opportunity” may be listed as a top-level or generic concept of generic domain 62. A top-level concept may be intended to apply to a broad, generic concept that may have a broad range of more specific types. For example, the concept “Sales Opportunity” may incorporate a wide range of types of names, labels, and other identifiers. The concept “Sales Opportunity” may include, or be extended by domain extension 64, one or more special cases of concepts that may be considered narrower or second-level concepts within the broader, top-level concept of “Sales Opportunity.” As a particular example, the concept “Sates Opportunity” may be extended by the concept “Won Opportunity” as a special case of the “Sales Opportunity” concept.

In one implementation, each concept may be encoded as a category with a name that begins with a lower case “c” (for concept) followed by a string (e.g., in camel case) based on one or more English words (in this example) for the concept, e.g., “cSalesOpportunity” for the “Sates Opportunity” concept, “cWonOpportunity” for the “Won Opportunity” special case concept within the “Sales Opportunity” concept, and so forth, as in the following example:

```
<category name=“cWonOpportunity”>
  <extends>cSalesOpportunity</extends>
  <restriction item=“cOpportunity State” op=“eq”>Closed
Won</restriction>
</category>
```

To recognize and identify these concepts in a collection of data, model and domain constructor 22 may identify clues such as lexical clues column headings, for example. Model and domain constructor 22 may use any of various language processing or analysis tools, such as tokenizing content, analyzing word stems and near matches, and otherwise evaluating lexical clues specific to each of one or more particular natural languages.

Model and domain constructor 22 may use the resulting set of clues from tokenizing and analyzing data item heading tokens to match concept keywords with the data item headings. Model and domain constructor 22 may took up concept keywords associated with one or more concepts in a business ontology, such as generic domain 62 that represents or is based on default business ontology and domain extension 64 that represents or is based on industry or business specific ontology, as potential candidates o explain the data item heading.

Model and domain constructor 22 may further validate likely candidate concepts as matches with data item headings using other clues, such as data patterns, the actual values of data listed under the data item heading, surrounding context of the data, and other factors. For example, when looking up candidate concepts for a given set of clues or potential matches, model and domain constructor 22 may assign priority to concepts that are signified by a greater number of matches between their concept keywords and the data item heading. For example, given a data item heading or title such as “PRODUCTNAME,” model and domain constructor 22 may initially identify the concept “caption” as a potential match with the data item heading, based on a match with the concept keyword of “name” associated with the concept “caption,” pending further validation. However, during the validating process, model and domain constructor 22 may identify a separate concept, “ProductName,” in the applicable business ontology, that has concept keywords of “product” and “name” that match the combination of two clues or data item heading tokens, “product” and “name,” from the data item heading.

Some business ontologies, such as generic domain 62 may not have a general concept of “ProductName” separate from the concept of “caption,” but this may be different in the case of a particular business ontology, such as domain extension 64 tailored to a particular business ontology of a particular business in which product names are of special significance. In this case, since model and domain constructor 22 identifies multiple concept keywords of a single concept in the business ontology that match multiple data item heading tokens of the data item heading, model and domain constructor 22 may select the concept “ProductName” instead of the concept “caption” as its final selection to identify a particular concept with the data item heading.

Model and domain constructor 22 may generate and output model 66 and domain 68 in various forms resulting from its analyses of data sources 38. Data sources 38 may be modeled (e.g., contain pre-defined relationships between data) or unmodeled (e.g., containing no pre-defined relationships between data). Model 66 includes defined relationships between the concepts of domain 68. In some examples, domain 68 includes assigned concepts to data sources 38. In other examples, domain 68 may also include analyses of the assigned concepts which provide an indication of future concepts that may be applied.

Identifying the one or more matches between the data item heading and the one or more concept keywords associated with the particular concept may therefore include validating the one or more matches between the data item heading and the one or more concept keywords associated with the particular concept against additional evidence from the data source. In one example, the data item heading is a first data item heading, and the additional evidence from the data source may include one or more of: values of data associated with the first data item heading, patterns of data associated with the first data item heading, and additional data item headings comparable to the first data item heading.

Once model and domain constructor 22 makes its final identification of a concept with a data item heading, model and domain constructor 22 may apply a concept tag in association with the data item heading. The concept tag may indicate the particular concept with which the data item heading is identified as being associated. Model and domain constructor 22 may output the concept tag in association with the data item heading to other systems, such as part of the output of a BI system to a consuming application such as recommender 28 or other BI user interface.

In some examples of FIG. 3A, model and domain constructor 22 may use the identification of the concept with the data item heading to identify a business intelligence portal output mode that corresponds to the particular concept and output the business intelligence portal output mode identified as corresponding to the particular concept. For example, model and domain constructor 22 may identify a time-ordered graph displaying a data visualization of the data under the data item heading as it varies over time, as a business intelligence portal output mode that corresponds to the particular concept of “time” that is identified as associated with the data item heading. In other examples, a consuming application, such as recommender 28, may use concept tags or other information, such as context 72 and report templates 70, with what it receives from model and domain constructor 22 to determine such an appropriate business intelligence portal output mode identified as corresponding to the particular concept.

Recommender 28 may use the determination of the appropriate business intelligence portal output mode to provide query recommendations 30 (e.g., queries, reports, and visualizations) to one or more users 12. Recommender 28 contains a knowledge base of query and report templates. Each of the templates defines where each of the concepts has to be added to fill the template. Recommender 28 may recommend query and report templates based on the presence of concepts over data, the scoring associated to the concepts, the scoring associated to the query and report templates, or the like. Recommender 28 may use domain 68 identified by model and domain constructor 22. In other examples, recommender 28 may use domain 68 which includes more than one domain and may also include ranking of each domain and associated analysis link between the ranked domains. Recommender 28 ranks the recommended templates, such as report templates 70, which could have some extension related to the domain analysis, by assigning them required concepts. In some examples, recommender 28 may return a recommendation, such as query recommendation 30 by each domain or an overall recommendation encompassing the first domain, the second, etc. In other examples, using the analyses of domain 68, recommender 28 may also recommend and rank the next analysis steps (e.g., queries, reports, and visualizations with query recommendations 30.

Query recommendations 30 may be a recommendation based on generic domain 62. In some examples, query recommendations 30 may be based on generic domain 62 and domain extension 64. In other examples, query recommendations 30 may be based on generic domain 62, domain extension 64, and a template and same set of concepts, filtered to avoid duplications.

By extending the knowledge base with the report templates used over a domain, such as domain extension 64, recommender 28 is able to generate more targeted report recommendations when combined with model 66 and domain 68 of model and domain constructor 22. Recommender 28 may also use the context of user 12 and report templates 70 that may allow recommender 28 to determine the appropriate queries, reports, or visualizations to suggest in an overall recommendation, such as query recommendation 30. Recommender 28 may also link the report templates, to define the typical domain related analysis scenario, which may provide the domain of industry best practice. In addition, the domain and industry expert may augment the system in a declarative way, such as the typical scenario, metrics, analysis steps, and related expressions, or the like. By using domain extension 64 with model and domain constructor 22 and recommender 28, the ontology based and declarative approach replaces the static traditional business intelligence static (vertical) applications with a dynamic and customized experience, not restricting user 12 to a set of pre-defined static reports. In addition, by using generic domain 62, model and domain constructor 22 and recommender 28 provide default behavior for any data source, without regard to whether domain extension 64 has been defined. Using generic domain 62 and domain extension 64 with model and domain constructor 22 creates a dynamic environment, such as computing environment 10, and allows user 12 to get relevant and targeted analysis with minimal work and a reduced number of clicks, and without having to build reports and visualizations.

Therefore, in an example in which the particular concept is identified as being or including time, the business intelligence portal output mode identified by model and domain constructor 22 as corresponding to the particular concept may include a data visualization of one or more variables in relation to time. In another example, the particular concept is identified as being or including a name or names, and the business intelligence portal output mode identified by model and domain constructor 22 as corresponding to the particular concept may include a data visualization of one or more variables in relation to entries corresponding to the names. The variables may be any type of data found in a data source, and may include time-ordered sets of data that vary relative to categories such as time, geography, business division, product line, and so forth. Examples of such variables may include sales, revenue, profits, margins, expenses, customer or user count, stock trading volume, stock share price, interest rates, or any other value of interest.

In one example, model and domain constructor 22 may output a graph that represents its best interpretation of a data set or a subset of a data set from data sources 38. This graph may represent how certain data elements are grouped together to represent a single entity (for example product_code and product_name may be different characteristics of product) and also how entities are related to one another (for example, a Product Line may include many Products).

An example of process 40 that model and domain constructor 22 performs may include one or more of the following: receiving a data set, extracting lexical clues from a data set or data source; determining a set of candidate concepts from a business ontology, such as generic domain 62 and domain extension 64, based at least in part on the lexical clues; using the business ontology as a network of concepts; and employing techniques (e.g., an activation spreading paradigm) to establish an interpretation context based on the candidate concepts. Model and domain constructor 22 may further use such an interpretation context along with data hints and data samples to disambiguate from among competing or potential candidate concepts, and set expectations for resolving data items for which lexical clues were not sufficient to identify applicable concepts with high confidence. Model and domain constructor 22 may use the disambiguated concepts and consult the business ontology in generating a model and domain, such as model 66 and domain 68 that may include organizing the input data items into categories (e.g., including one or more data items) and metrics. Model and domain constructor 22 may also generate or suggest whole-part navigation paths among the data item headings, categories, or other semantic information.

In one implementation, each analysis may be encoded as an area with a name by a string (e.g., in camel case) based on one or more English words (in this example) for the analysis, e.g., “Sales Pipeline” and a domain with a name that begins with a lower case “d” (for domain) followed by a string (e.g., in camel case) based on one or more English words (in this example) for the concept, e,g., “Bales”, and so forth, as in the following example:

```
<analysisArea name=“Sales Pipeline” domain=“dSales”>
...
  <category name=“cWonOpportunity”>
    <extends>cSalesOpportunity</extends>
    <restriction item=“cOpportunity State” op=“eq”>Closed
  Won</restriction>
  </category>
...
</analysisArea>
```

In an example of process 41 of FIG. 3B, to recognize and identify these concepts in a collection of data, model and domain constructor 22 and recommender 28 may also use existing information, such as existing report 74 with existing model 67 and existing domain 69 along with identifying clues, as described in FIG 3A. Model and domain constructor 22 may further validate likely candidate concepts as matches with data item headings using other clues, such as data patterns, the actual values of data listed under the data item heading, surrounding context of the data, and other factors.

Existing report 74 is an existing modeled data source that contains existing model 67 and existing domain 69 that can be used in combination with model 66 and domain 68 to increase the amount of concepts and relationships available to recommender 28. Existing model 67 is similar to model 66 as described in FIG. 3A. Existing model 67 includes pre-defined relationships between concepts from existing domain 69 of existing report 74. Existing domain 69 is similar to domain 68 as described in FIG. 3A. Existing domain 69 includes the assigned concepts to the data of existing report 74.

For example, when looking up candidate concepts for a given set of clues or potential matches, model and domain constructor 22 may assign priority to concepts that are signified by a greater number of matches between their concept keywords and the data item heading. For example, given a data item heading or title such as “PRODUCTNAME,” model and domain constructor 22 may initially identify the concept “caption” as a potential match with the data item heading, based on a match with the concept keyword of “name” associated with the concept “caption,” pending further validation. However, during the validating process, model and domain constructor 22 may identify a separate concept, “ProductName,” in the applicable business ontology, that has concept keywords of “product” and “name” that match the combination of two clues or data item heading tokens, “product” and “name,” from the data item heading.

Some business ontologies, such as generic domain 62 may not have a general concept of “ProductName” separate from the concept of “caption,” but this may be different in the case of a particular business ontology, such as domain extension 64 tailored to a particular business ontology of a particular business in which product names are of special significance. In other examples, such business ontologies may be included in existing information, such as existing report 74 which may include report model 67 and report domain 69. In this case, since model and domain constructor 22 identifies multiple concept keywords of a single concept in the business ontology that match multiple data item heading tokens of the data item heading, model and domain constructor 22 may select the concept “ProductName” instead of the concept “caption” as its final selection to identify a particular concept with the data item heading.

Identifying the one or more matches between the data item heading and the one or more concept keywords associated with the particular concept may therefore include validating the one or more matches between the data item heading and the one or more concept keywords associated with the particular concept against additional evidence from the data source. In one example, the data item heading is a first data item heading, and the additional evidence from the data source may include one or more of: values of data associated with the first data item heading, patterns of data associated with the first data item heading, and additional data item headings comparable to the first data item heading.

Once model and domain constructor 22 makes its final identification of a concept with a data item heading, model and domain constructor 22 may apply a concept tag in association with the data item heading. The concept tag may indicate the particular concept with which the data item heading is identified as being associated. Model and domain constructor 22 may output the concept tag in association with the data item heading to other systems, such as part of the output of a BI system to a consuming application such as recommender 28 or other BI user interface.

By extending the knowledge base with the report templates used over a domain, such as domain extension 64, recommender 28 is able to generate more targeted report recommendations when combined with model 66 and domain 68 of model and domain constructor 22. In the example of FIG. 3B, model and domain constructor may also use existing report 74 to provide recommender with existing domain 69 and existing model 67. Recommender 28 may use existing domain 69 and existing model 67 along with the context of user 12 and report templates 70 that may allow recommender 28 to determine the appropriate queries, reports, or visualizations to suggest in an overall recommendation, such as query recommendation 30.

In some examples of FIG. 3B, model and domain constructor 22 may use the identification of the concept with the data item heading to identify a business intelligence portal output mode that corresponds to the particular concept and output the business intelligence portal output mode identified as corresponding to the particular concept. For example, model and domain constructor 22 may identify a time-ordered graph displaying a data visualization of the data under the data item heading as it varies over time, as a business intelligence portal output mode that corresponds to the particular concept of “time” that is identified as associated with the data item heading. In other examples, a consuming application, such as recommender 28, may use concept tags or other information, such as context 72 and report templates 70, with domain 68, report domain 69, model 66, and report model 67 from model and domain constructor 22 to determine such an appropriate business intelligence portal output mode identified as corresponding to the particular concept. Recommender 28 may use the determination of the appropriate business intelligence portal output mode to generate query recommendations 30 (e.g., queries, reports, and visualizations) to one or more users 12. Recommender 28 may also use existing model 67 and existing domain 69 to link with model 66 and domain 68 to generate query recommendations 30.

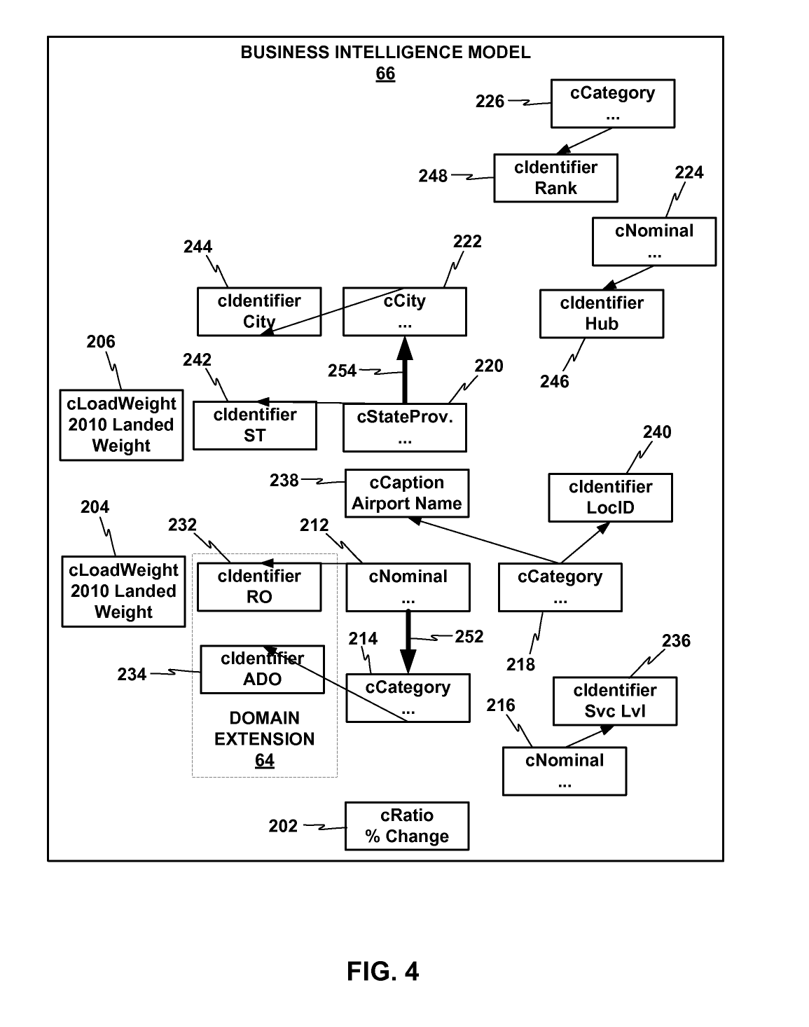

FIG. 4 is a block diagram illustrating details of an example model and domain that may be generated based on a data set, according to one or more aspects of the present disclosure. In one non-limiting example of FIG. 4, business intelligence (BI) model 66 is illustratively depicted with various types of blocks representing various types of information, and with various organizational relations depicted among the blocks. Each of the blocks is labeled with a label beginning with a tower case letter “c” to indicate a concept in the business ontology, to which the information associated with the block conforms, with the letter “c” followed by a label indicating, in an unbroken camel case string in this example, the particular type of information represented by that concept.

In particular, in semantic BI model 66, metric blocks 202, 204, and 206 represent metrics; category blocks 212, 214, 216, 218, 220, 222, 224, and 226 represent categories which are groupings of data item headers (e.g., Airport Name, LocID (location ID)); and data item header blocks 232, 234, 236, 238, 240, 242, 244, 246 and 248 represent data item headers that may be identifiers in general, or specific types of identifiers such as captions, for example. BI model 66 also contains whole-part associations, represented by thick black arrow connectors 252 and 254, between categories that model and domain constructor 22 finds to have whole-part associations between them. BI model 66 may also indicate relationships between blocks such as between identifiers and captions or names associated with the identifiers. As an example, cCategory block 218 (for a “category” concept) is indicated to have associations with both cIdentifier block 240, in which a LocID data item heading is mapped to “cIdentifier” or identifier concept, and with cCaption block 238 (for a. “caption” concept) in which an Airport Name data item heading is mapped to “cCaption” or a caption concept.

For example, model and domain constructor 22 may identify that a State may have a whole-part association with a City that is apart of that State, as represented in organize semantic BI model 66 by whole-part association connector 254 between “cStateProvince” category block 220, representing the geographical concept of a state or province in the business ontology, and “cCity” category block 222, representing the geographical concept of a city in the business ontology. Thus, each category block may have an associated concept from the business ontology associated with the category block, such that model and domain constructor 22 maps the information in the category block to the business ontology concept from the business ontology. For example, the category associated with data item heading “ST” is interpreted to be a state (e.g., in the U.S.A. or Germany), province (e.g., in Canada or France), prefecture (e.g., in Japan), or other top-level internal division of a country, categorized as one equivalent concept, named concept “cStateProvince” and with category block 220 mapped to this concept in this example.

As also shown in FIG. 4, BI model 66 may include whole-part navigation paths between different information blocks representing associations between the information represented therewith. Some illustrative examples of whole-part navigation paths in BI model 66 include the arrow path between cCategory category block 214 and cIdentifier ADO data item header block 234, and the arrow path between cNominal category block 212 and &Identifier ADO data item header block 232. Model and domain constructor 22 may generate or suggest the whole-part navigation paths based on lexical clues and relationships among the underlying data such as data item headings that are proximate to a data item of interest, for example. Model and domain constructor 22 may lack independent information about the nature of the underlying data item headers “ADO” and “RO” in the data source, but may correlate data values for these two items, and thereby establish a whole-part association between these data items as indicated in BI model 66.

In other examples, domain extension 64 created by an expert in business ontology or a particular company or business may provide independent information about the nature of the underlying data item headers “ADO” and “RO” in the data source with regard to a specific industry or business, thereby establishing a whole-part association between the data item as indicated in BI model 66.

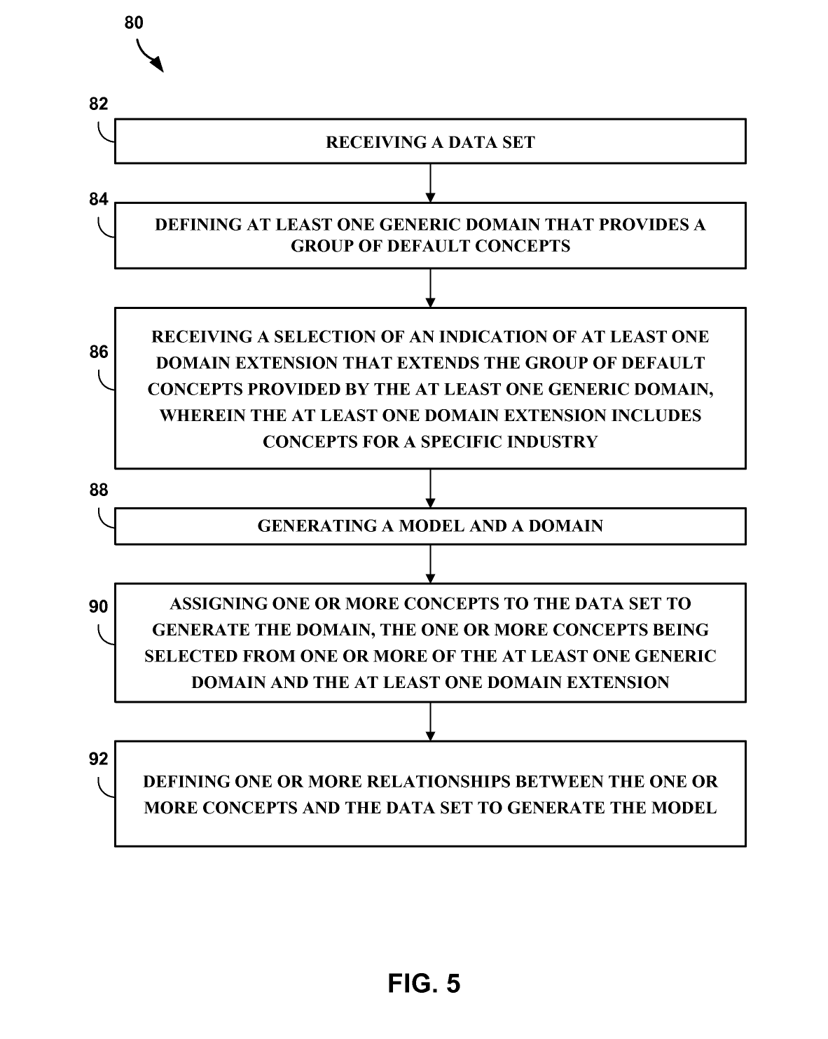

FIG. 5 is a flow chart illustrating an example process 80 for modeling of enterprise data in an enterprise system 4, according to one or more aspects of the present disclosure. In one or more examples, process 80 may be executed by one or more of computing device 16 or enterprise BI system 13, as shown in FIGS. 1-2.

For purposes of illustration only, the process of FIG. 5 is described as being performed by at least model and domain constructor 22. Model and domain constructor 22 may receive a data set (82). Model and domain constructor 22 may define at least one generic domain that provides a group of default concepts (84). Model and domain constructor 22 may receive a selection of an indication of at least one domain extension that extends the group of default concepts provided by the at least one generic domain, wherein the at least one domain extension includes concepts for a specific industry (86), Model and domain constructor 22 may generate a model and a domain (88) by assigning one or more concepts to the data set to generate the domain, the one or more concepts being selected from one or more of the at least one generic domain and the at least one domain extension (90) and defining one or more relationships between the one or more concepts and the data set to generate the model (92).

In some examples, the data set includes data with no pre-defined relationships. In other examples, the data set includes modeled data with pre-defined relationships from an existing report. In some examples with an existing report, generating the model and the domain further comprises generating a report model and a report domain based on the existing report. In other examples, generating the model and domain comprises generating the model and domain using smart metadata (SMD).

In another example, the process of FIG, 5 may also include generating, by the one or more processors and based on a user input, a context of the model and the domain, receiving, by the one or more processors, a plurality of recommendations, wherein the plurality of recommendations is based on a combination comprising one or more of the report templates, the context of the model and the domain, and the generated model and domain, and generating, by the one or more processors and based on the plurality of recommendations, an overall recommendation. In some examples, the plurality of recommendations is based on a combination further comprising the report model and the report domain of the existing report. In other examples, the overall recommendation includes at least one of a query, report, or visualization.

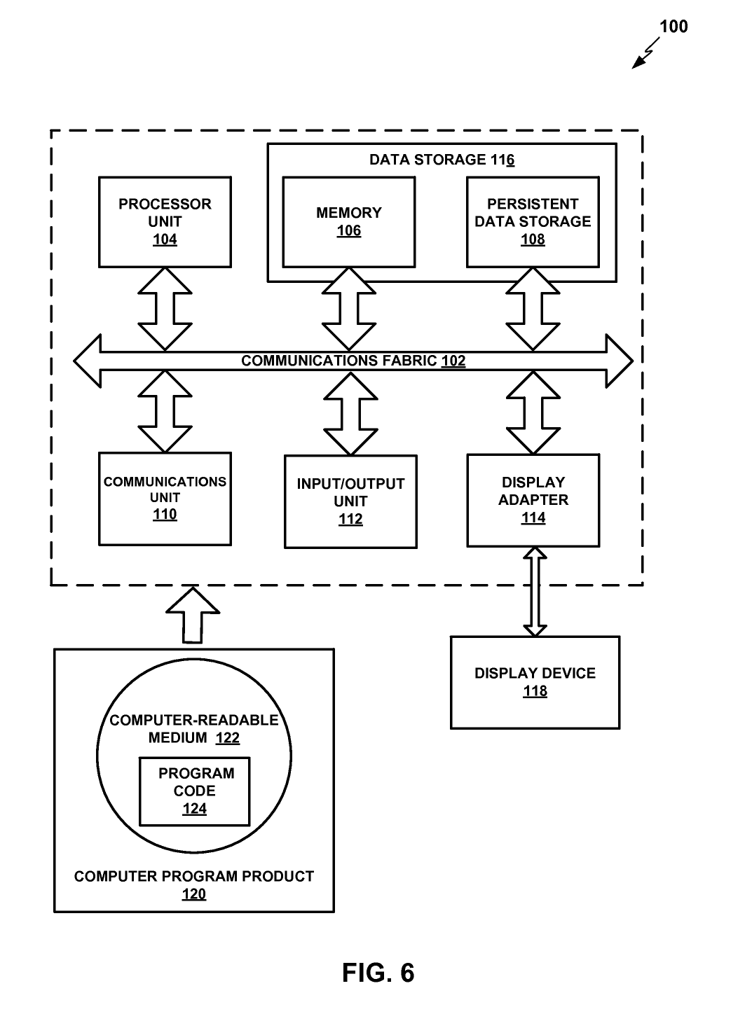

FIG. 6 is a flow chart illustrating an example of process 100 for executing a model and domain constructor with a domain extension as part of an enterprise BI system, according to one or more aspects of the present disclosure. In some examples, computing device 100 may be enterprise BI system 13 or computing device 16, as depicted in FIGS. 1-2. In other examples, computing device 100 may be a server, such as one of web servers 14A or application servers 14B, and/or computing device 16A, as depicted in FIG. 2. Computing device 100 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind. Other implementations of a computing device 100 may include a computer having capabilities or formats other than or beyond those described herein.

In the illustrative example of FIG. 6, computing device 100 includes communications fabric 102, which provides communications between processor unit 104, memory 106, persistent data storage 108, communications unit 110, and input/output (I/O) unit 112. Communications fabric 102 may include a dedicated system bus, a general system bus, multiple buses arranged in hierarchical form, any other type of bus, bus network, switch fabric, or other interconnection technology. Communications fabric 102 supports transfer of data, commands, and other information between various subsystems of computing device 100.

Processor unit 104 may be a programmable central processing unit (CPU) configured for executing programmed instructions stored in memory 106. In another illustrative example, processor unit 104 may be implemented using one or more heterogeneous processor systems in which a main processor is present with secondary processors on a single chip. In yet another illustrative example, processor unit 104 may be a symmetric multi- processor system containing multiple processors of the same type. Processor unit 104 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 104 may include a multi-core processor, such as a dual core or quad core processor, for example. Processor unit 104 may include multiple processing chips on one die, and/or multiple dies on one package or substrate, for example. Processor unit 104 may also include one or more levels of integrated cache memory, for example. In various examples, processor unit 104 may comprise one or more CPUs distributed across one or more locations.

Data storage 116 includes memory 106 and persistent data storage 108, which are in communication with processor unit 104 through communications fabric 102. Memory 106 can include a random access semiconductor memory (RAM) for storing application data, i.e., computer program data, for processing. While memory 106 is depicted conceptually as a single monolithic entity, in various examples, memory 106 may be arranged in a hierarchy of caches and in other memory devices, in a single physical location, or distributed across a plurality of physical systems in various forms. While memory 106 is depicted physically separated from processor unit 84 and other elements of computing device 100, memory 106 may refer equivalently to any intermediate or cache memory at any location throughout computing device 100, including cache memory proximate to or integrated with processor unit 104 or individual cores of processor unit 104.

Persistent data storage 108 may include one or more hard disc drives, solid state drives, flash drives, rewritable optical disc drives, magnetic tape drives, or any combination of these or other data storage media. Persistent data storage 108 may store computer-executable instructions or computer-readable program code for an operating system, application files comprising program code, data structures or data files, and any other type of data. These computer-executable instructions may be loaded from persistent data storage 108 into memory 106 to be read and executed by processor unit 104 or other processors. Data storage 116 may also include any other hardware elements capable of storing information, such as, for example and without limitation, data, program code in functional form, and/or other suitable information, either on a temporary basis and/or a permanent basis.

Persistent data storage 108 and memory 106 are examples of physical, tangible, non-transitory computer-readable data storage devices. Some examples may use such a non-transitory medium. Data storage 116 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 104 can also be suitably programmed to read, load, and execute computer-executable instructions or computer-readable program code for a model and domain constructor 22, as described in greater detail above. This program code may be stored on memory 106, persistent data storage 108, or elsewhere in computing device 100. This program code may also take the form of program code 124 stored on computer-readable medium 122 comprised in computer program product 120, and may be transferred or communicated, through any of a variety of local or remote means, from computer program product 120 to computing device 80 to be enabled to be executed by processor unit 104, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 104 can be suitably programmed to read, load, and execute instructions of the operating system,

Communications unit 110, in this example, provides for communications with other computing or communications systems or devices. Communications unit 110 may provide communications through the use of physical and/or wireless communications links. Communications unit 110 may include a network interface card for interfacing with a LAN 16, an Ethernet adapter, a Token Ring adapter, a modem for connecting to a transmission system such as a telephone tine, or any other type of communication interface. Communications unit 110 can be used for operationally connecting many types of peripheral computing devices to computing device 100, such as printers, bus adapters, and other computers. Communications unit 110 may be implemented as an expansion card or be built into a motherboard, for example.

The input/output unit 112 can support devices suited for input and output of data with other devices that may be connected to computing device 100, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 112 may also include any type of interface for video output in any type of video output protocol and any type of monitor or other video display technology, in various examples. It will be understood that some of these examples may overlap with each other, or with example components of communications unit 110 or data storage 116. Input/output unit 112 may also include appropriate device drivers for any type of external device, or such device drivers may reside elsewhere on computing device 100 as appropriate.

Computing device 80 also includes a display adapter 114 in this illustrative example, which provides one or more connections for one or more display devices, such as display device 118, which may include any of a variety of types of display devices. It will be understood that some of these examples may overlap with example components of communications unit 100 or input/output unit 112. Input/output unit 112 may also include appropriate device drivers for any type of external device, or such device drivers may reside elsewhere on computing device 120 as appropriate. Display adapter 114 may include one or more video cards, one or more graphics processing units (GPUs), one or more video-capable connection ports, or any other type of data connector capable of communicating video data, in various examples. Display device 118 may be any kind of video display device, such as a monitor, a television, or a projector, in various examples.

Input/output unit 112 may include a drive, socket, or outlet for receiving computer program product 120, which comprises a computer-readable medium 122 having computer program code 124 stored thereon. For example, computer program product 120 may be a CD-ROM, a DVD-ROM, Blu-Ray disc, a magnetic disc, a USB stick, a flash drive, or an external hard disc drive, as illustrative examples, or any other suitable data storage technology.

Computer-readable medium 122 may include any type of optical, magnetic, or other physical medium that physically encodes program code 124 as a binary series of different physical states in each unit of memory that, when read by computing device 100, induces a physical signal that is read by processor 104 that corresponds to the physical states of the basic data storage elements of storage medium 122, and that induces corresponding changes in the physical state of processor unit 104. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 104, thereby physically causing or configuring processor unit 104 to generate physical outputs that correspond to the computer-executable instructions, in a way that causes computing device 100 to physically assume new capabilities that it did not have until its physical state was changed by loading the executable instructions comprised in program code 124.

In some illustrative examples, program code 124 may be downloaded over a network to data storage 116 from another device or computer system for use within computing device 100. Program code 124 comprising computer-executable instructions may be communicated or transferred to computing device 100 from computer-readable medium 122 through a hard-line or wireless communications link to communications unit 110 and/or through a connection to input/output unit 112. Computer-readable medium 122 comprising program code 124 may be located at a separate or remote location from computing device 100, and may be located anywhere, including at any remote geographical location anywhere in the world, and may relay program code 124 to computing device 100 over any type of one or more communication links, such as the Internet and/or other packet data networks. The program code 124 may be transmitted over a wireless Internet connection, or over a shorter- range direct wireless connection such as wireless LAN, Bluetooth™, WiFi™, or an infrared connection, for example. Any other wireless or remote communication protocol may also be used in other implementations.

The communications link and/or the connection may include wired and/or wireless connections in various illustrative examples, and program code 124 may be transmitted from a source computer-readable medium 122 over non-tangible media, such as communications links or wireless transmissions containing the program code 124. Program code 124 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 100.

As will be appreciated by a person skilled in the art, aspects of the present disclosure may be embodied as a method, a device, a system, such as a computer system, or a computer program product, for example. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the from of a computer program product embodied in one or more computer-readable data storage devices or computer-readable data storage components that include computer-readable medium(s) having computer readable program code embodied thereon.

For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, a system, apparatus, or device used to store data, but does not include a computer readable signal medium. Such system, apparatus, or device may be of a type that includes, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present invention may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, ISON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present invention are described herein with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also he loaded onto a computer, other programmable data processing apparatus, or other devices to cause a series of operational steps to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions fur implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel processing threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of executable instructions, special purpose hardware, and general-purpose processing hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

1-8. (canceled)

9. A computer system, comprising:
at least one processor, wherein the at least one processor is configured to:
receive a data set;
define at least one generic domain that provides a group of default concepts;
receive a selection of an indication of at least one domain extension that extends the group of default concepts provided by the at least one generic domain, wherein the at least one domain extension includes concepts for a specific industry; and
generate based on the data set and a combination of the at least one generic domain and the at least one domain extension, a model and a domain, wherein the generating comprises:
assigning one or more concepts to the data set to generate the domain, the one or more concepts being selected from one or more of the at least one generic domain and the at least one domain extension; and
defining one or more relationships between the one or more concepts and the data set to generate the model.

10. The computer system of claim 9, wherein the data set includes modeled data with pre-defined relationships from an existing report.

11. The computer system of claim 10, wherein generating the model and the domain further comprises generating a report model and a report domain based on the existing report.

12. The computer system of claim 9, wherein the at least one process is further configured to:
generate, based on a user input, a context of the model and the domain;
receive a plurality of report templates;
provide a plurality of recommendations, wherein the plurality of recommendations is based on a combination comprising one or more of the report templates, the context of the model and the domain, and the generated model and domain; and
generate based on the plurality of recommendations, an overall recommendation.

13. The computer system of claim 12, wherein the plurality of recommendations is based on a combination further comprising the report model and the report domain of the existing report.

14. The computer system of claim 12, wherein the overall recommendation includes at least one of a query, a report, or a visualization.

15. A computer program product comprising a computer-readable storage medium having program code embodied therewith, the program code executable by at least one processor to:
receive a data set;
define at least one generic domain that provides a group of default concepts;
receive a selection of an indication of at least one domain extension that extends the group of default concepts provided by the at least one generic domain, wherein the at least one domain extension includes concepts for a specific industry; and
generate based on the data set and a combination of the at least one generic domain and the at least one domain extension, a model and a domain, wherein the generating comprises:
assigning one or more concepts to the data set to generate the domain, the one or more concepts being selected from one or more of the at least one generic domain and the at least one domain extension; and
defining one or more relationships between the one or more concepts and the data set to generate the model.

16. The computer program product of claim 15, wherein the data set includes modeled data with pre-defined relationships from an existing report.

17. The computer program product of claim 16, wherein generating the model and the domain further comprises generating a report model and a report domain based on the existing report.

18. The computer program product of claim 15, wherein the program code is further executable by the at least one processor to:
generate, based on a user input, a context of the model and the domain;
receive a plurality of report templates;
provide a plurality of recommendations, wherein the plurality of recommendations is based on a combination comprising one or more of the report templates, the context of the model and the domain, and the generated model and domain; and
generate based on the plurality of recommendations, an overall recommendation.

19. The computer program product of claim 18, wherein the plurality of recommendations is based on a combination further comprising the report model and the report domain of the existing report.

20. The computer program product of claim 18, wherein the overall recommendation includes at least one of a query, a report, or a visualization.
